(19) United States
(12) Patent Application Publication
(10) Pub. No.: US 2011/0320205 A1
(43) Pub. Date: Dec. 29, 2011

(54) ELECTRONIC BOOK READER

(75) Inventors: CHIEN-CHOU CHEN, Tu-Cheng (TW); CHIH-HUNG CHEN, Tu-Cheng (TW)

(73) Assignee: HON HAI PRECISION INDUSTRY CO., LTD., Tu-Cheng (TW)

(21) Appl. No.: 13/085,374

(22) Filed: Apr. 12, 2011

(30) Foreign Application Priority Data
Jun. 29, 2010 (CN) 201010212497.5

(51) Int. Cl. G10L 13/08

(52) U.S. Cl. 704/260; 704/E13.011

(57) ABSTRACT

An electronic book reader includes a display, an audio output device, a text obtaining module, a storing module, a text displaying module, a text analyzing module, a text highlighting module, a speech synthesis module, a player module, and a synchronization control module. The text obtaining module obtains a text from a text source. The storing module stores the text. The text displaying module displays the text on the display. The text analyzing module divides the text into a plurality of segments according to punctuations of the text, and read a selected segment. The speech synthesis module converts the selected segment into speech. The synchronization control module sends a command to the text analyzing module for reading the segment, and sends the segment to the text highlighting module and speech synthesis module synchronously.

This application is related to co-pending U.S. patent application entitled “ELECTRONIC BOOK READER AND TEXT TO SPEECH CONVERTING METHOD”, Attorney Docket No. US33482, U.S. application Ser. No. ______ filed on ______.

### BACKGROUND

1. Technical Field

The present disclosure relates to electronic book readers, and particularly to, an electronic book reader that plays the text.

2. Description of Related Art

An electronic book (e-book) is a text file providing the digital media equivalent of a conventional printed book. E-books are usually read on personal computers or smart phones, or on dedicated hardware devices known as e-book readers. An e-book reader usually has a player to play the texts of the e-books. However, the user may not know which part is being played due to inattention.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of a hardware of an electronic book reader in accordance with an embodiment.

FIG. 2 is a block diagram of the electronic book reader of FIG. 1.

FIG. 3 is a flow chart of a displaying method of the electronic book reader of FIG. 2 in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

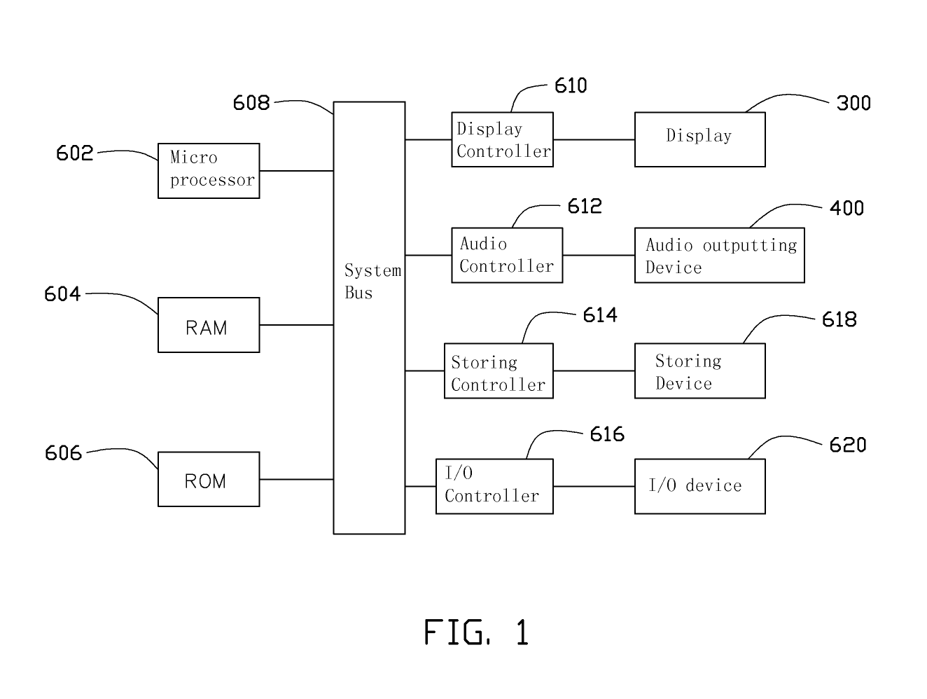

Referring to FIG. 1, an electronic book reader includes a micro processor 602, a random access memory (RAM) 604, a read only memory (ROM) 606, a system bus 608, a displaying controller 610, an audio controller 612, a storing controller 614, a displaying module 300, an audio outputting device 400, a storing device 618, an I/O controller 616, and an I/O device 620. The system bus 608 is connected to the micro processor 602, the RAM 604, the ROM 606, the displaying controller 610, the audio controller 612, the storing controller 614 and the I/O controller 616. The display 300 is connected to the displaying controller 610. The audio outputting device 400 is connected to the audio controller 612. The storing device 618 is connected to the storing controller 614. The I/O device 620 is connected to the I/O controller 616.

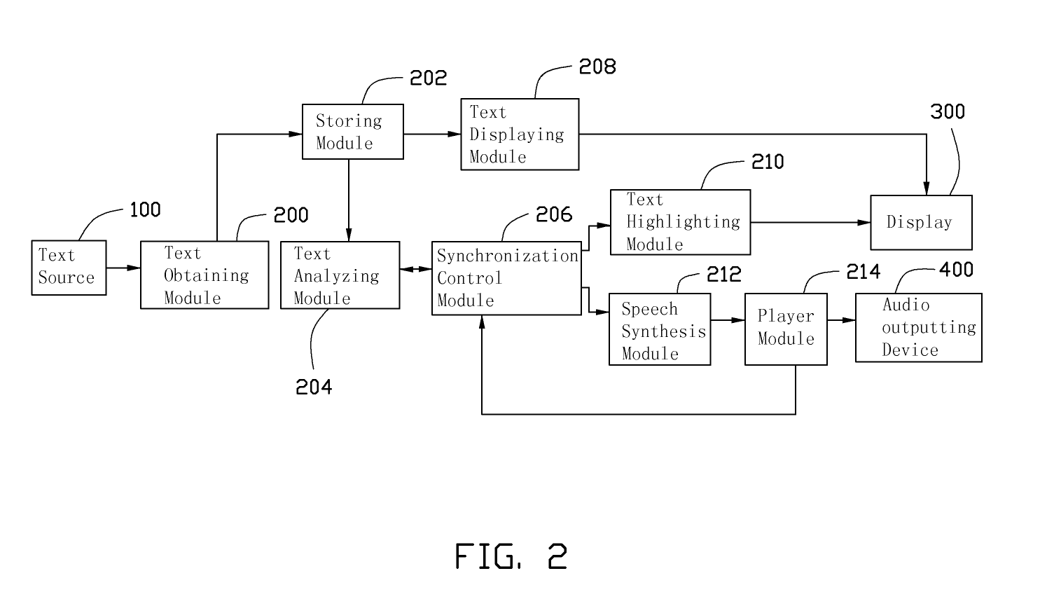

Referring to FIG. 2, an electronic book reader includes a display 300, an audio output device 400, a text obtaining module 200, a storing module 202, a text analyzing module 204, a synchronization control module 206, a text displaying module 208, a text highlighting module 210, a speech synthesis module 212, and a player module 214. Texts processed by the electronic book reader are from a text source 100. The text obtaining module 200 is connected to the storing module 202. The storing module 202 is connected to the text analyzing module 204 and the text displaying module 208. The text analyzing module 204 is connected to the synchronization control module 206. The synchronization control module 206 is connected to the text highlighting module 210 and the speech synthesis module 212. The speech synthesis module 212 is connected to the player module 214. The player module 214 is connected to the audio output device 400 and the synchronization control module 206. The text displaying module 208 and the text highlighting module 210 are both connected to the display 300.

The display 300 is configured to display texts. The audio output device 400 is configured to output audio signals. In one embodiment, the audio output device 400 is a speaker or headphones. The text obtaining module 200 is configured to obtain a text and send the text to the storing module 202. The text analyzing module 204 is configured to divide the text into a plurality of segments according to punctuations in the text, and is configured to read segments and label the segments in an order.

The synchronization control module 206 is configured to send segments read by the text analyzing module 204 to the text highlighting module 210 and the speech synthesis module 212 at the same time. The synchronization control module 206 is configured to receive a feedback message from the player module 214 and then send a revoking command for revoking the highlighting effect of the segment to the text highlighting module 210. The speech synthesis module 212 is configured to convert the text segment to speech and send the speech to the player module 214 to play. The player module 214 is configured to play the speech and send a feedback message to the synchronization control module 206 after playing the speech. The feedback message indicates that the player module 214 is finished playing the speech.

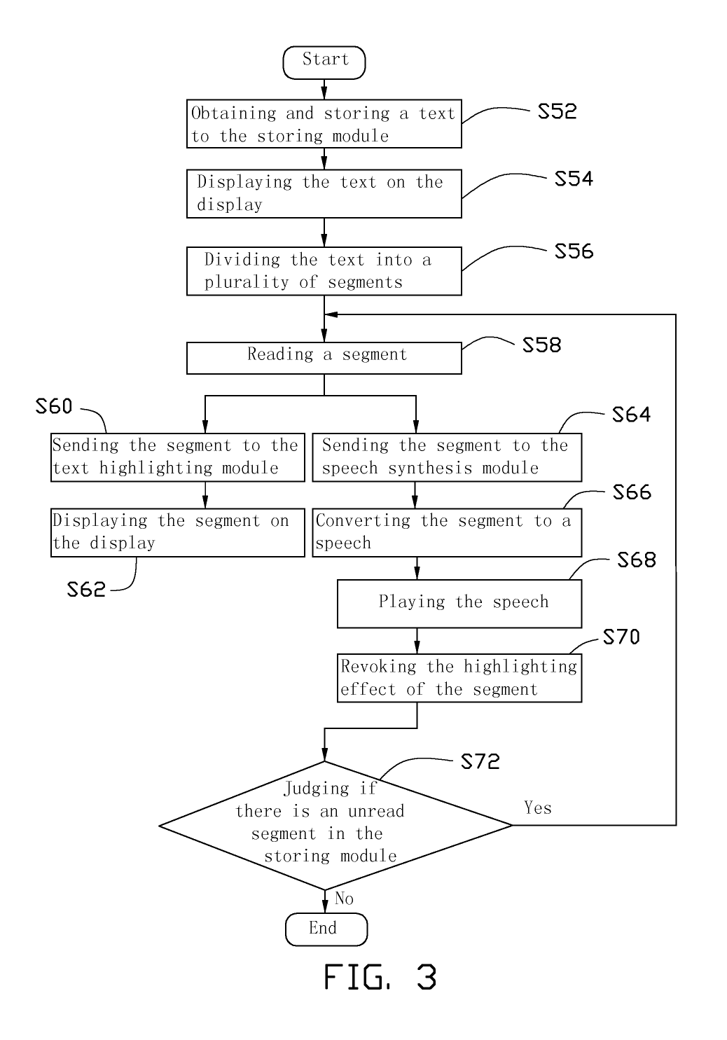

Referring to FIG. 3, a method for displaying content on the electronic book reader is shown. An embodiment of the method is as follows.

In step S52, the text obtaining module 200 obtains a text from the text source 100 and stores the text in the storing module 202.

In step S54, the text displaying module 208 displays the text stored in the storing module 202 on the display 300.

In step S56, the text analyzing module 204 divides the text into a plurality of segments according to punctuations of the text, such as commas, periods, question marks, and exclamation points.

In step S58, the text analyzing module 204 reads a segment and then labels the segment.

In step S60, the synchronization control module 206 sends the segment to the text highlighting module 210.

In step S62, the text highlighting module 210 highlights the segment and displays the segment on the display 300.

In step S64, the synchronization control module 206 sends the segment to the speech synthesis module 212.

In step S64, the synchronization control module 206 sends the segment to the speech synthesis module 212.

In step S66, the speech synthesis module 212 converts the segment into a speech and sends the speech to the player module 214.

In step S68, the player module 214 plays the speech from the speech synthesis module 212 and then sends a feedback message to the synchronization control module 206.

In step S70, the synchronization control module 206 sends a revoking command for revoking the highlighting effect of the text to the text highlighting module 210, and the text highlighting module 210 revokes the highlighting effect of the segment.

In step S72, the synchronization control module 206 sends a message for reading the next segment of the text to the text analyzing module 204. The text analyzing module 204 judges if there is unread segment of the text in the storing module 202. If so, turns to step S58, if not, the process is over.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. An electronic book reader, comprising:
a display;
an audio output device;
a text obtaining module, the text obtaining module configured to obtain a text from a text source;
a storing module, the storing module configured to store the text;
a text displaying module, the text displaying module configured to display the text on the display;
a text analyzing module, the text analyzing module configured to divide the text into a plurality of segments according to punctuations of the text after the text displaying module displays the text on the display;
a text highlighting module, the text highlighting module configured to highlight a selected segment from the plurality of segments;
a speech synthesis module, the speech synthesis module configured to convert the selected segment into a speech;
a player module, the player module configured to play the speech; and
a synchronization control module, the synchronization control module configured to send the selected segment to the text highlighting module and the speech synthesis module synchronously;
wherein the text highlighting module highlights the selected segment when the speech is played.

2. The electronic book reader of claim 1, wherein the text analyzing module is configured to divide the text into the plurality of segments after the text displaying module displays the text on the display.

3. The electronic book reader of claim 1, wherein the punctuations comprise commas, periods, question marks, and exclamation points.

4. The electronic book reader of claim 1, wherein the text analyzing module is configured to label the selected segment after the selected segment is read.

5. The electronic book reader of claim 1, wherein the player module is configured to send a feedback message to the synchronization control module after playing the speech, the feedback message means that the player module is finished playing the speech.

6. The electronic book reader of claim 5, wherein the synchronization control module is configured to send a revoking command to the text highlighting module for revoking highlight effect of the selected segment after receiving the feedback message.

7. The electronic book reader of claim 1, wherein the text highlighting module is configured to revoke highlight effect of the selected segment after the player module finishes playing the speech.

8. A method for displaying content on an electronic book reader, comprising:
obtaining a text from a text source;
storing the text;
displaying the text;
dividing the text into a plurality of segments according to punctuations of the text;
highlighting a selected segment from the plurality of segments;
converting the selected segment into a speech; and
playing the speech.

9. A method for displaying content on an electronic book reader, comprising:
providing an electronic book reader, the electronic book reader comprising:
a display;
an audio output device;
a text obtaining module, the text obtaining module configured to obtain a text from a text source;
a storing module, the storing module configured to store the text;
a text displaying module, the text displaying module configured to display the text on the display;
a text analyzing module, the text analyzing module configured to divide the text into a plurality of segments according to punctuations of the text after the text displaying module displays the text on the display;
a text highlighting module, the text highlighting module configured to highlight a selected segment from the plurality of segments;
a speech synthesis module, the speech synthesis module configured to convert the selected segment into a speech;
a player module, the player module configured to play the speech; and
a synchronization control module, the synchronization control module configured to send the selected segment to the text highlighting module and the speech synthesis module synchronously;
wherein the text highlighting module highlights the selected segment when the speech is played;
the text obtaining module obtaining the text from the text source;
the storing module storing the text;
the text displaying module displaying the text on the display;
the text analyzing module dividing the text into the plurality of segments according to the punctuations of the text;
the text highlighting module highlighting the selected segment from the plurality of segments;
the speech synthesis module converting the selected segment into the speech; and
the player module playing the speech.
